(19) United States
(12) Patent Application Publication
(10) Pub. No.: US 2024/0143409 A1
(43) Pub. Date: May 2, 2024

(54) CLOUD COMPUTING RESOURCE MANAGEMENT

(71) Applicant: SAP SE, Walldorf (DE)

(72) Inventors: Keshav Bhardwaj, Bangalore (IN); Ganesan Karuppasamy, Bangalore (IN); Ashok Govinda Rao, Bangalore (IN); Prasanth RJ, Bangalore (IN)

(21) Appl. No.: 18/052,078

(22) Filed: Nov. 2, 2022

(51) Int. Cl. G06F 9/50; G06F 9/451

(52) U.S. Cl. CPC G06F 9/505; G06F 9/451

(57) ABSTRACT

Computer-readable media, methods, and systems are disclosed for tracking ephemeral assets in a cloud environment by creating a knowledge graph model comprising a plurality of nodes and a plurality of relationships between the plurality of nodes. The media, method, and system further include determining properties of the knowledge graph model for a first node at a first time and creating a first adjacency list for the first node at the first time. Additionally, properties of the knowledge graph model are determined for the first node at a second time and a second adjacency list is created for the first node at the second time. By comparing the first adjacency list to the second adjacency list, at least one change that occurred between the first time and the second time can be determined.

### TECHNICAL FIELD

Embodiments generally relate to cloud computing resource management, and more particularly to tracking ephemeral assets.

Technologies relating to cloud-based assets are growing exponentially. The adoption of multi-cloud-based services, platforms, and interfaces lacking meaningful visibility and control may leave organizations without a firm handle on the complexity of cloud inventory assets. This can create an unclear picture of the size of a customer's or user's cloud resources. Lack of visibility makes it harder to keep tabs on a corresponding cloud infrastructure, leading to inventory inaccuracies, poor service performance, and disjointed cloud processes.

A large quantity of resources may be consumed by cloud-based information technology (IT) assets. Accordingly, there needs to be greater control and optimization of valuable cloud assets. There is therefore also a need for systems to provide for central asset management tools to manage multi cloud assets.

### SUMMARY

Disclosed embodiments address the above-mentioned problems by providing one or more non-transitory computer-readable media storing computer-executable instructions that, when executed by at least one processor, perform a method for tracking ephemeral assets in a cloud environment, the method including: creating a knowledge graph model including a plurality of nodes and a plurality of relationships between the plurality of nodes; determining properties of the knowledge graph model for a first node at a first time; creating a first adjacency list for the first node at the first time; determining properties of the knowledge graph model for the first node at a second time, wherein the second time is after the first time; creating a second adjacency list for the first node at the second time; and comparing the first adjacency list to the second adjacency list to determine at least one change that occurred between the first time and the second time.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1 is an embodiment of a system for implementing aspects described herein.

FIG. 2A is an exemplary directed graph and FIG. 2B is an exemplary undirected weighted graph.

FIG. 3A shows a first exemplary graph model.

FIG. 3B represents a second exemplary graph model.

FIG. 4 shows an exemplary method for creating a graph between two times.

FIG. 5 shows a method for backend flow.

FIG. 6 illustrates a method for calculating drift between two different times.

FIG. 7 is an exemplary adjacency list for a datacenter DC01 at time t1.

FIG. 8 is an exemplary adjacency list for a datacenter DC01 at time t2.

FIG. 9 is a diagram illustrating a sample computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

The present disclosure relates to management of computing and infrastructure assets in federated multi-clouds from a single control plane. With recent advances and innovations in cloud datacenter virtualization at compute, network and storage layers and hyper-automation solutions, such as Kubernetes and HCI (Hyper converged Infrastructure), to deploy cloud services on demand, there are challenges for cloud organizations to allocate, track and trace datacenter asset inventory. A real-time asset directory is described herein, which acts as a catalogue to map physical inventory with ephemeral run-time state of workloads at compute, storage and network level. As disclosed herein, an asset provision and decommission algorithm on asset inventory catalogue assigns automated unique identifiers for physical and transient (ephemeral cloud assets). An asset lifecycle management algorithm is defined which periodically determines and updates capacity projections based on utilization patterns. The resultant asset catalogue can be used for enterprise cost, capacity, and audit management.

Specifically, this disclosure defines processes for enabling ephemeral assets to be tagged, traced, and managed for federated multi-cloud deployments. Users may frequently acquire new assets and may frequently decommission assets that are no longer needed. Ephemeral assets may be physical assets such as hardware that have temporary or ephemeral instances of applications executing thereon. Ephemeral assets may mean assets that can be added, deleted, or modified with respect to the system or environment over time. An organization may wish to track these assets in terms of cost and usage. Tracking such ephemeral assets in a virtual machine (VM) environment may be more difficult than tracking physical assets. A cloud environment presents unique challenges to keep track of the inventory and their respective states. There is also a need to allow a user to search the history of the ephemeral assets, which may be used for audit purposes.

A knowledge graph can be used for modelling different problems. In an embodiment, a knowledge graph is used for modelling assets, cost and usage. Additionally, a machine learning model may be created on top of the knowledge graph as described herein.

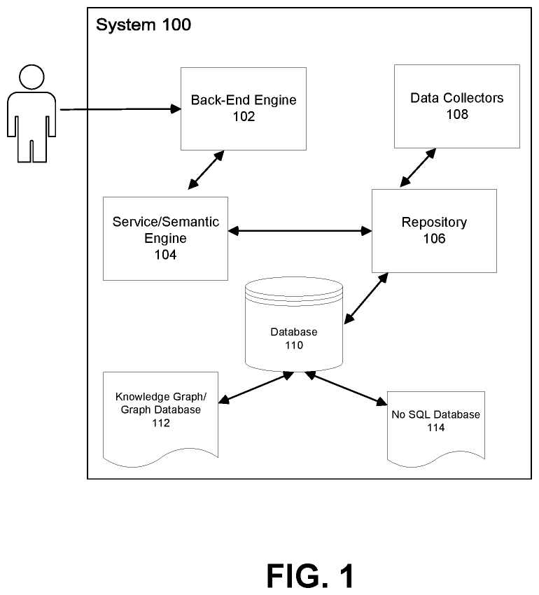

FIG. 1 presents the framework for an asset management system 100. The system 100 can include back-end engine 102, service/semantic engine 104, repository 106, data collectors 108, databases 110, and specific databases, such as knowledge graph/graph database 112, and No SQL database 114. More or fewer elements may be included in this system depending on the required resources.

### Data Modelling

A graph, G, is an ordered pair (V (G), E(G)), where V (G) represents the set of nodes (or vertices) and E(G) the set of edges (or links) between pairs of elements of V (G). The number of nodes, also known as the size of the graph, is written as |V (G)| and the number of edges as |E(G)|. Two nodes vi and vj are neighbors (or adjacent) if they are linked, that is, if (vi, vj)∈E(G). One can distinguish between directed edges, which connect a source node to a target node, and undirected edges, when there is no such concept of orientation. In the first case, the graph is called directed or digraph. A graph is weighted, if there is a weight (or cost) wi,j associated the edge (vi, vj). It is classified as simple if it does not contain multiple edges (two or more edges connecting the same pair of nodes) and it does not contain self-loops (an edge connecting a node to itself).

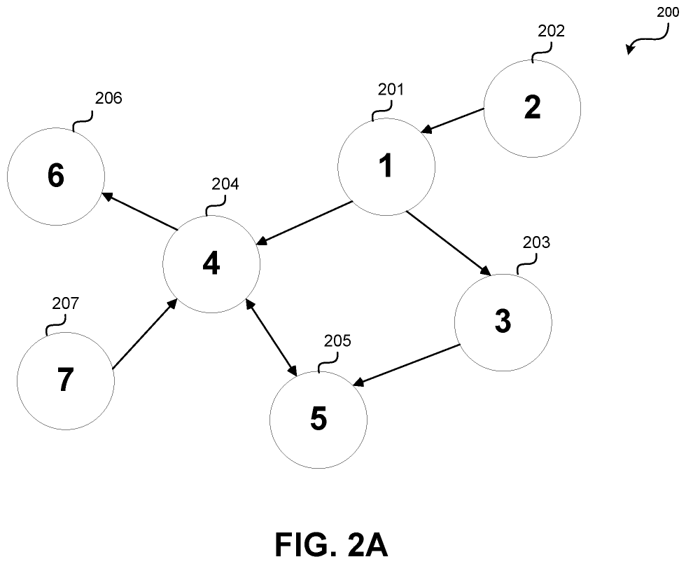

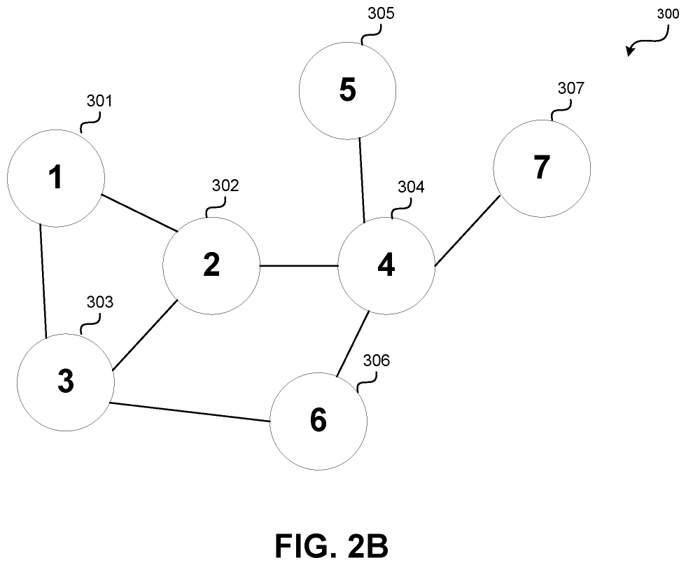

FIG. 2A is a representation of a simple directed graph 200 and FIG. 2B is a representation of a simple undirected weighted graph 300. A graph 200, 300 is usually represented mathematically as an adjacency matrix denoted as A, and Ai,j is 1 (or wi,j) when (vi, vj)∈E(G) and is 0 otherwise. In an example, all nodes (such as nodes 201, 202, 203, 204, 205, 206, 207, or nodes 301, 302, 303, 304, 305, 306, 307) are labeled with consecutive integer numbers starting from 1 to |V (G)|. Most topological measures/metrics are related to the concepts of paths and graph connectivity. A path is a sequence of nodes in which each consecutive pair of nodes in the sequence is connected by an edge. It may also be useful to think of the path as the sequence of edges that connect those nodes. Two nodes are connected if there is a path between them and are disconnected if no such path exists. A set of nodes is called a connected component if all its node pairs are connected.

For example, node 204 is connected to node 206, node 205, node 207 and node 201 in FIG. 2A. Similarly, node 201 is connected to node 202, node 203, and node 204. In the directed graph 200, information is directed from node 202 to node 201 and then further to node 203 and/or node 204. From node 204, information may be directed to node 206 and/or bi-directionally from/to node 205. From node 203, information may be directed to node 205 and then to node 204 and to node 206. Another input may be from node 207 to node 204, and then further to node 206. Thus, in this example, node 206 is the end/output of the path and node 202 or node 207 represent inputs to the path.

With reference to FIG. 2B, an undirected graph is shown. In this example, node 301 is directly connected to node 302 and node 303. Additionally, node 303 is directly connected to node 302 and node 306. Node 306 may be directly connected to node 304 and node 303. Node 304 may be directly connected to node 302, node 307 and node 305. Additionally, each node may have a specified weight.

A knowledge graph is a knowledge base that is made machine readable with the help of logically consistent, linked graphs that together constitute an interrelated group of facts. Graph databases are often used to store knowledge graph data and the logic that describes interconnections and context.

Data modelling is core of system design to understand granularities. In some embodiments, Property Graphs (PG) and Resource Description Framework (RDF) could be used to model data in knowledge graph. In an example herein, a labeled property graph model in Neo4j DB can be used to model the data for the assets.

A labeled property graph contains nodes, relationships, properties, and labels. A node can be an entity itself (such as a software application) or it can a characteristic or measurement of an entity (such as CPU usage). A property is an attribute of a node and nodes may contain more than one property. Each node will be of a particular class or a type and can be identified as such using labels. Relationships connect nodes and form the graph. Relationships connecting the nodes may have a name, direction, and properties associated therewith. Thus, a first node may be a characteristic of a second node, and in such cases, the first node is a property of the second node. This property-based relationship between the two nodes is usually represented by an edge in a graph between the two nodes.

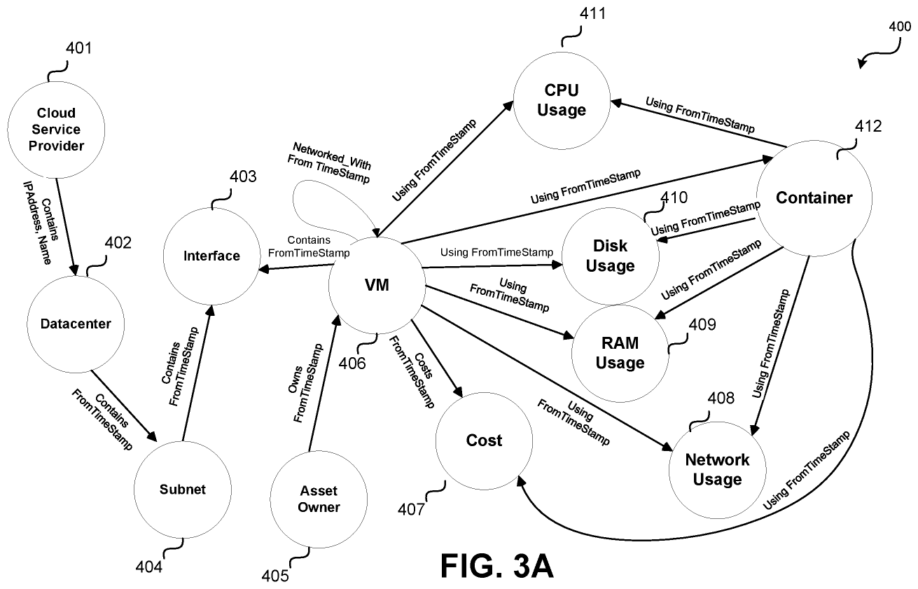

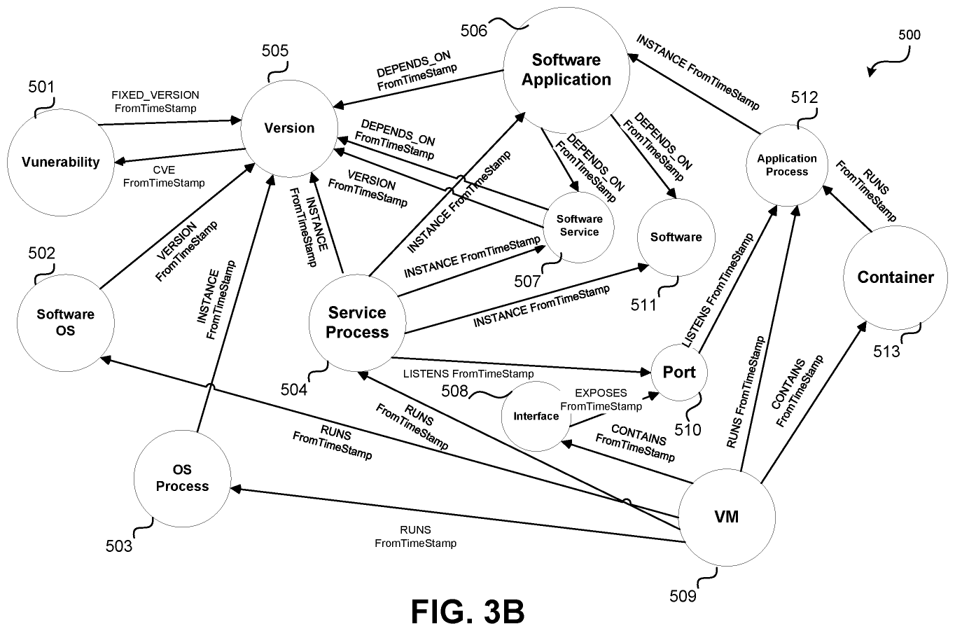

With respect to FIG. 3A, a cloud service provider can support multiple VMs, which are connected in a network known as a data center. Each data center can have multiple subnets, and multiple VMs which are connected to each other forming clusters. Each VM may have multiple containers, each container can have multiple software applications running on it, and each software application can have different versions and different vulnerabilities.

FIG. 3A shows an exemplary model 400. In an embodiment, the model 400 has a label (type) for each node. Exemplary labels may be VM, Container, RAM_Usage, CPU_Usage, Disk_Usage, Network_Usage, Asset_Owner/Employee/People, Datacenter, Subnet, Cloud_Service_Provider, Interface, Cost, Port, Application Process, Service Process, Software Service, Software Application, Software, OS Process, Software OS, Version, and Vulnerability. More or fewer labels and nodes are possible. In some embodiments, usages can be measured on a per-application instance, such as a specific tenant, or for all applications and for all tenants. Additionally, other labels and nodes are possible. Model 400 also illustrates multiple relationship types between each of the nodes, such as Contains, Using, Networked_With, Owns, Costs, Runs, Listens, Exposes, Instance, Depends_On, Version, Fixed_Version, and CVE.

Each node 401-412 shown in model 400 may have multiple properties or characteristics associated therewith. Some exemplary properties for the nodes shown in FIG. 3A are as follows. For node 401, labeled as Cloud_Service_Provider, properties may include ID and Name. For node 402, labeled as Datacenter, properties may include ID and Name. For node 403, labeled as Interface, properties may include ID, Name, and IPAddress. For node 404, labeled as Subnet, properties may include ID, Subnetmask, and Zone. For node 405, labeled as Asset_Owner/Employee/People, properties may include ID, Name, and Email. For node 406, labeled as VM, properties may include ID, Name, CloudVendor, Hostname, CPU, RAM, and DiskSize. For node 407, labeled as Cost, properties may include ID and Asset_Cost. For node 408, labeled as Network_Usage, properties may include ID, Outgress, and Ingress. For node 409, labeled as RAM_Usage, properties may include ID and RAMUsage. For node 410, labeled as Disk_Usage, properties may include ID and Size. For node 411, labeled as CPU_Usage, properties may include ID and CPUUsage. For node 412, labeled as Container, properties may include ID, Name, CloudVendor, and Hostname.

Using such a model 400, a user can determine elements such as which vendor has which data center, which data center includes which VMs, and which VMs include which containers. A user can also determine what the usage is for each element, such as CPU usage and/or RAM usage, which may be used to determine the cost. A user can also determine information such as: what are the VMs and how are they connected, what interfaces does each VM have, and what subnet is each interface connected to. Additionally, a time stamp is included for each relationship/node, which can represent when in time the particular node was added.

In an embodiment, the model can be used for applications running on virtual machines and containers and their vulnerabilities. FIG. 3B represents the graph model 500. FIG. 3B is thus similar to FIG. 3A in that they have similar nodes with similar labels and properties (e.g., VM, Container, etc.), but are different in having different nodes and edges elsewhere in the graph.

### Semantic Modelling

An important part of the graph data is how it changes through time. Graphs are almost always dynamic—they change shape and size with time. Asset data for any organization also changes with time. For example, Cost and Usage for any asset may change and/or a new asset such as a VM or container may be created and/or deleted. For semantic integration, temporal information is integrated into the asset knowledge graph. Relationships like “Using” and “Contains” can be associated with a timestamp to accommodate all changes. In an example, a Unix integer timestamp can be used to ease computation for time during querying data.

For example, in FIG. 3B, model 3B may include node 501 representing a vulnerability, node 502 representing a software OS, node 503 representing an OS process, node 504 representing a service process, node 505 representing a version, node 506 representing a software application, node 507 representing a software service, node 508 representing an interface, node 509 representing a VM, node 510 representing a port, node 511 representing a software, node 512 representing an application process, and node 513 representing a container. A vulnerability may be a defect, security flaw, or weakness with respect to the system itself, or one or more particular applications on the system. A version may be a particular version of the system itself, or of one or more particular applications on the system.

The relationship between vulnerability node 501 and version node 505 may be that the vulnerability node 501 sends a “FIXED_VERSION FromTime Stamp” to version node 505, and version node 505 returns a “CVE FromTimeStamp” to vulnerability node 501.

The service process node 504 may send “INSTANCE FromTimeStamp” to multiple nodes, such as software node 511, software service node 507, software application node 506, and/or version node 505. The service process node 504 may also send “LISTENS FromTimeStamp” to port node 510. The service process node 504 may also receive “RUNS FromTimeStamp” from VM node 509.

Version node 505 may receive “DEPENDS_ON FromTimeStamp” from software application node 506 and software service node 507. Version node 505 may also receive “VERSION FromTimeStamp” from software service node 507. Version node 505 may receive “INSTANCE FromTimeStamp” from service process node 504 and from OS process node 503. Version node 505 may also receive “VERSION FromTimeStamp” from software OS node 502.

VM node 509 may send “RUNS FromTimeStamp” to application process node 512, OS process node 503, and/or service process node 504. VM node 509 may also send “CONTAINS FromTimeStamp” to container node 513 and interface node 508.

Interface node 508 may send “EXPOSES FromTimeStamp” to port node 510. Port node 510 also sends “LISTENS FromTimeStamp” to application process node 512 and receives “LISTENS FromTimeStamp” from service process node 504.

Software application node 506 may send “DEPENDS_ON FromTimeStamp” to software service node 507, software node 511, and version node 505. Software application node 506 may receive “INSTANCE FromTimeStamp” from application process node 512 and service process node 504. Container node 513 may receive “CONTAINS FromTimeStamp” from VM node 509 and may send “RUNS FromTimeStamp” to application process node 512.

If any drift or changes happen in the system, it can cause a vulnerability at the particular node that is being modified. Thus, the drift/changes must be monitored and tracked to anticipate and account for any vulnerabilities. Real-time tracking of the assets with the associated properties and time stamps allows for a user to pre-empt any issues caused by potential vulnerabilities before a problem occurs.

Currently in order to determine the assets, an organization may perform a routine scan of the entire system. However, there is a need for a real-time tracking for assets in a cloud environment. In one embodiment, every node will have a timestamp of when it is added to the system. A query can be performed for a given node, multiple nodes, or the entire system to determine what has happened between two time points.

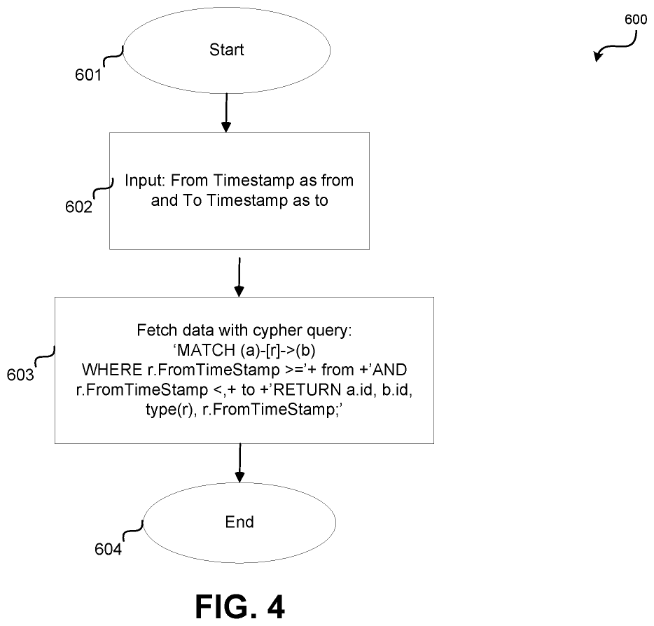

An exemplary method 600 to create a graph between two times is shown in FIG. 4. At step 601, the method starts such as by a user initiating the process from a user interface. A user may select particular properties such as the beginning time, and the end time, and the particular system or node to be analyzed. At step 602, the input may be “FromTimestamp as from and To TimeStamp as to”. Additionally, if there is more than one cloud environment, a user will also input a name or ID for a particular cloud environment to be reviewed. At step 603, a cypher query may be used to fetch the data, such as from a database 110 or repository 106. An exemplary query is: ‘MATCH (a)-[r]->(b) WHERE r.FromTimeStamp>=′+ from +′AND r.FromTimeStamp<′+ to +′RETURN a.id, b.id, type(r), r.FromTimeStamp’. As explained herein, the data is used to create a knowledge graph model. The creation of the knowledge graph model includes the addition of relationships and connections between each of the nodes. In other words, the raw data in database 110 or repository 106 does not expressly show all of the relationship among the various data entities. At step 604, the process ends and an output is provided to the user, such as via a user interface of a computing device. The output may be a visual depiction of the data, such as a knowledge graph model. The output may also be specific requested data that is extracted from the knowledge graph model.

### Backend and User Interface

With reference to FIG. 1, data can be periodically collected from different sources (data collectors 108), such as Splunk, Cloud and other discovery applications, and vulnerability scanners. This data can be stored in a non-relational database, such as NoSQL Database 114, such as Elastic Search or MongoDB etc. Then, this data is used for implementing and creating a modelling graph using a database 110, such as Neo4j Database. Data from knowledge graph/graph database 112 (which includes relationships) and NoSQL database 114 may be combined in database 110, and data may be stored in repository 106.

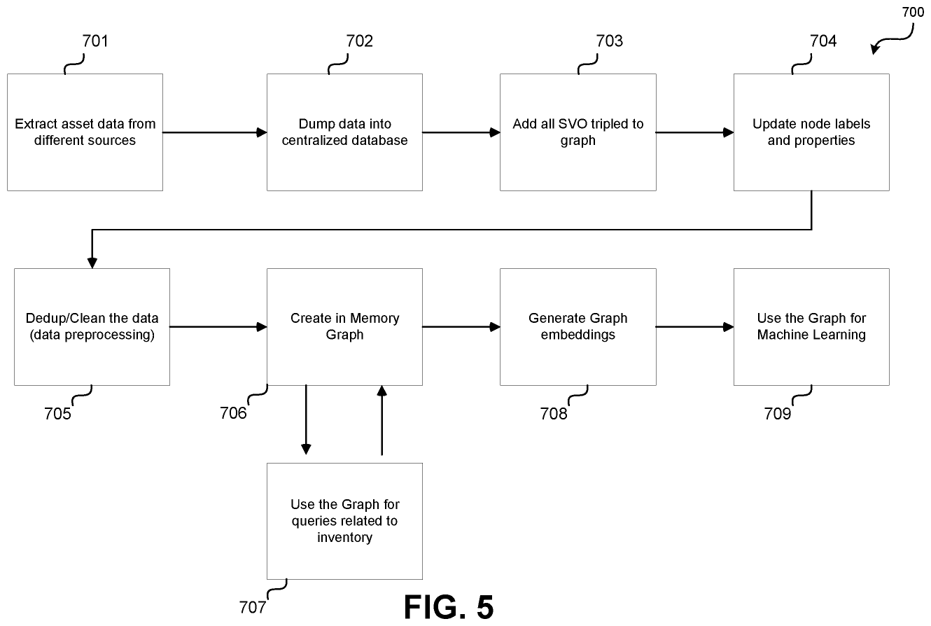

FIG. 5 represents a method 700 for completed backend flow. At step 701, asset data is extracted from different sources, such as by data collectors 108. At step 702, data is dumped into a centralized database, such as database 110. A service/semantic engine 104 and/or back-end engine 102 may be used to perform the following steps based on data from repository 106 and database 110. At step 703, all subject-verb-object (SVO) data is added (tripled) to the graph. In one example, SVO data is as follows: “VM” is the subject, “contains” is the verb, and “interface” is the object. The service/semantic engine may include a glossary and/or rules for particular node labels and relationships. At step 704, the node labels and properties are updated to indicate the current state of all the nodes and properties. At step 705, deduplication and clean-up on the data is performed, such as data pre-processing. At step 706, an in-memory graph is created. At step 707, the graph may be used for queries related to inventory, such as from a use via a user interface. At step 708, graph embeddings may be generated for enabling machine learning. Embeddings may be encoding of graph vertices to be used for machine learning. For example, this may used in predicting cost, RAM usage, recommendation for a new VM creation, etc. At step 709, the graph is used for machine learning. Machine learning can then be used for providing recommendations and/or predictions to the user.

In some embodiments, a machine learning model is provided in the context of a computer hardware and software architecture environment. In an embodiment, machine learning may include supervised learning and/or unsupervised learning. Supervised learning is defined by labeled datasets that are used to train algorithms into classifying data and/or predicting outcomes. Supervised learning may include classification algorithms and regression algorithms. Classification algorithms may include linear classifiers, support vector machines, decision trees, and random forest. Regression models include linear regression, logistic regression, and polynomial regression.

In an embodiment, the knowledge graph model may provide an input into a supervised machine learning model. Such a supervised learning model may be used to output a prediction to a user, related to changes in assets in the cloud environment. For example, the machine learning model may provide a prediction of the cost of adding a particular node at a particular time. In another example, the machine learning model may provide a recommendation for where in the environment a new node should be added such that it will result in the lowest cost and/or most efficient use of resources.

Unsupervised learning models may be used for determining hidden patterns in data and include clustering, association, and dimensionality reduction. Clustering techniques assign similar data points into groups. The association method uses rules to find relationships between variables in a dataset. Dimensionality reduction may be used to reduce the number of data points to a manageable size when the number of features in a dataset is too large. In an embodiment, the knowledge graph model may provide an input into an unsupervised machine learning model. Such an unsupervised machine learning model may provide insights from the new data that were not contemplated by the user. For example, the machine learning model may provide a recommendation that a node should be removed for better efficiency of the system or predict a particular node where a vulnerability may occur in the future.

A user interface may include a number of features. Exemplary features include: access to all asset inventory with filters based on datacenter/network zones/cloud service provider; drift management report; searching assets based on types (VM/Container) within given time windows; searching assets within network ranges/zones; searching assets with a port; searching assets owned by an owner; usage and cost distribution; vulnerabilities for a given VM; and all assets with a given vulnerabilities. For example, a user may select a particular datacenter and request a drift management report for a particular time period, such as September 2022. A user may select a particular asset and request a report for a specific time period to determine usage and costs over time. The user interface display can include the time series data and graphs/images showing changes over time.

### Drift Management

Drift management focuses on the auditing, verification, and management of infrastructure changes in a datacenter IT environment. The auditing activities provided by drift management assists in keeping a datacenter operationally compliant with the organizational rules of an IT environment.

A knowledge graph with temporal information helps to determine the drifts/changes for a given node through time. For example, a graph could include ports opened, VM/Containers created, vulnerabilities introduced, etc. The FromTimeStamp is representative of the time when a particular node was added to the model. For example, a user may determine when the costs were greatest or least over time. A user can also determine what assets are owned by which owner. Tracking usage and cost over time for multiple nodes allows a user to determine many things.

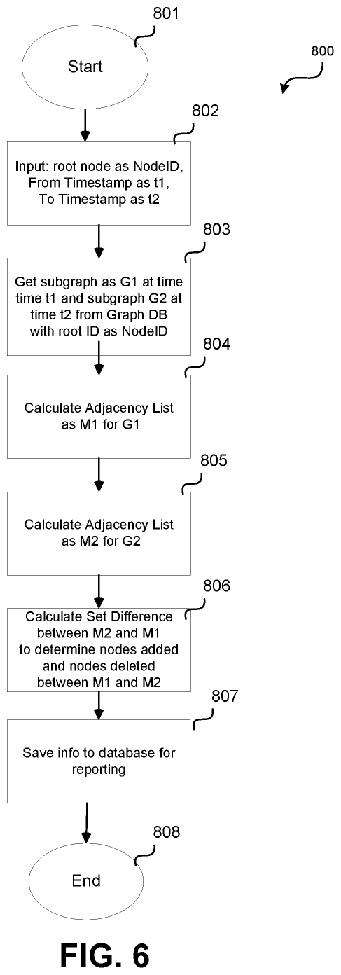

FIG. 6 illustrates a method 800 to calculate drift by querying graph snapshots at two different times t1 and t2 and calculating the differences. The graph format allows for additional data to be shown in an easily readable format. The relationships and connections between nodes can be easily viewed in the knowledge graph model. In an embodiment, the method compares two versions of a graph and determines the changes in linear time complexity.

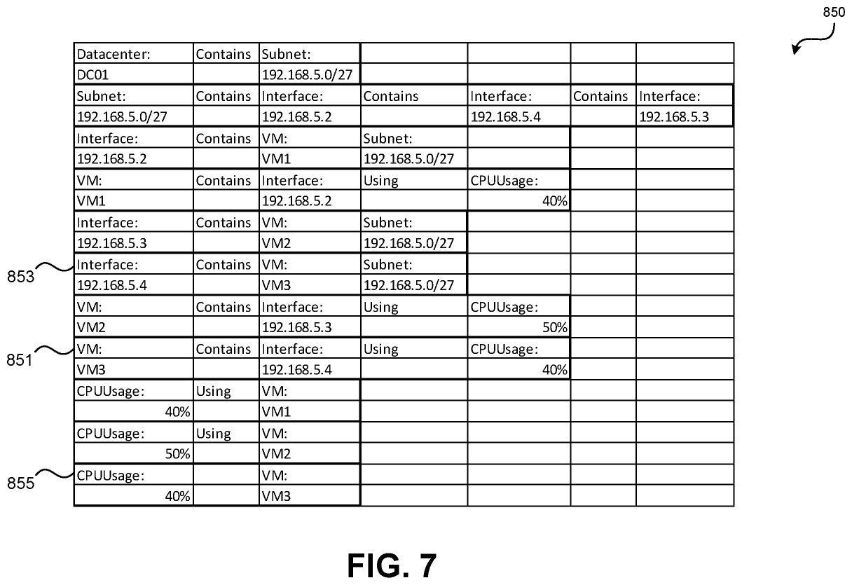

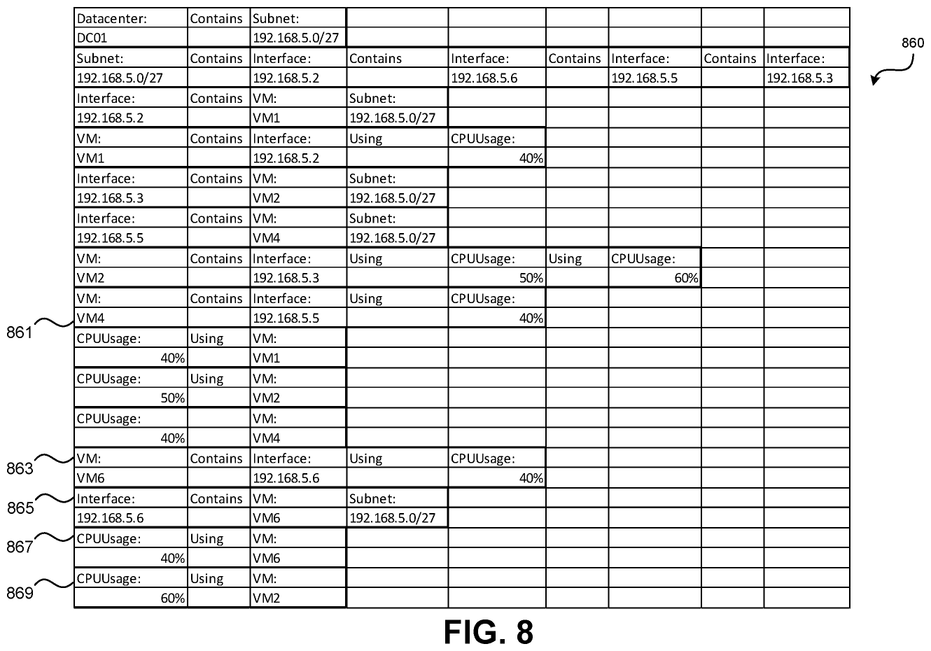

At step 801, the process is initiated, such as by a user at a user interface. At step 802, the input is “root node as NodeID, From Timestamp as t1, and To Timestamp at t2.” At step 803, the system gets a subgraph as G1 from graph database at time t1 and a subgraph as G2 from graph database at time t2 with the root ID as NodeID. In an embodiment, each node is read, and the associated data stored to create a subgraph. At step 804, the system calculates a first adjacency list as M1 for subgraph G1. In an embodiment, an adjacency list is a list of all nodes, wherein each item in the list consists of the list of nodes directly connected to it. An adjacency list may contain all the properties related to a particular node, and the relationships between the particular node and all adjacent nodes. An exemplary first adjacency list 850 is shown in FIG. 7. At step 805, the system calculates a second adjacency list as M2 for subgraph G2. An exemplary second adjacency list is shown in FIG. 8. At step 806, the system calculates the set difference between M2 and M1 to determine nodes that have been added between M1 and M2 as well as nodes deleted between M1 and M2. At step 807, the information is saved to the database for reporting. At step 808, the process ends.

In one example, FIG. 7 represents adjacency list 850 for graphs for datacenter DC01 at time t1 to create a first Set 1. Additionally, FIG. 8 represents adjacency list 860 for graphs for datacenter DC01 at time t2 to create a second Set 2. Determining the difference between adjacency list 850 and adjacency list 860 gives all nodes added between time t1 and t2. For example, VM4 (at 861), VM6 (at 863), the VM6 interface (at 865), the VM6 CPU usage (at 867) were added between time t1 and t2. Additionally, the CPU usage for VM2 (at 869) was increased to 60% between time t1 and t2. Additionally, determining the difference between adjacency list 850 and adjacency list 860 gives the nodes deleted between time t1 and t2. For example, VM3 (at 851), the VM3 interface (at 853), and the VM3 CPU usage (at 855) were deleted between time t1 and t2.

Machine learning may use these models to help a user predict certain things. For example, if a user wants to create a new cloud VM, a machine learning algorithm can make a recommendation as to which cloud system this should be created on to be most cost-effective and efficient. For a particular VM, the ML system can predict for a particular VM, what is the cost in the near future. For example, a machine learning (ML) algorithm may predict what the cost for the next fiscal quarter will be for a particular system with specific nodes and properties.

The disclosure provides a method for modeling assets into a graph and predicting a future cost for the infrastructure using a machine learning model. Additionally, using the data for cost and usage for assets, a usage and cost trend analysis and predictions can be conducted.

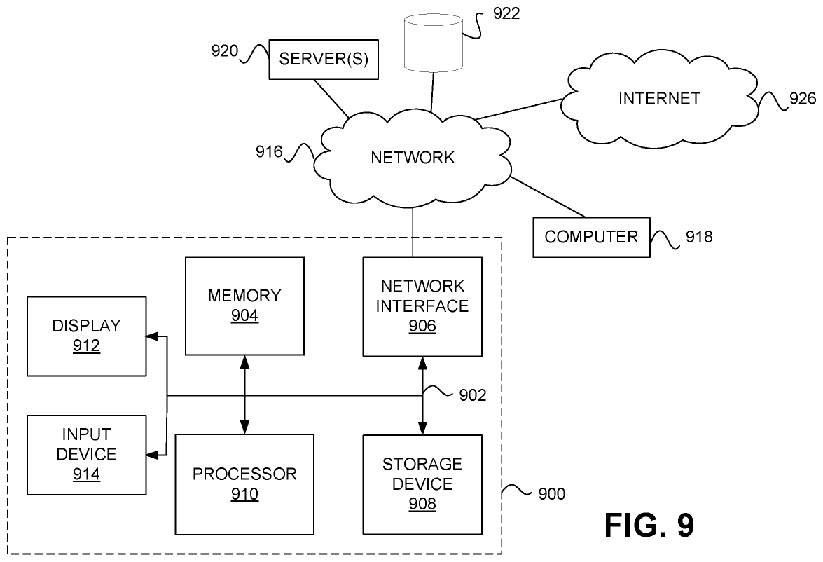

FIG. 9 is a diagram illustrating a sample computing device architecture for implementing various aspects described herein. Computer 900 can be a desktop computer, a laptop computer, a server computer, a mobile device such as a smartphone or tablet, or any other form factor of general- or special-purpose computing device containing at least one processor. Depicted with computer 900 are several components, for illustrative purposes. Certain components may be arranged differently or be absent. Additional components may also be present. Included in computer 900 is system bus 902, via which other components of computer 900 can communicate with each other. In certain embodiments, there may be multiple busses or components may communicate with each other directly. Connected to system bus 902 is processor 910. Also attached to system bus 902 is memory 904. Also attached to system bus 902 is display 912. In some embodiments, a graphics card providing an input to display 912 may not be a physically separate card, but rather may be integrated into a motherboard or processor 910. The graphics card may have a separate graphics-processing unit (GPU), which can be used for graphics processing or for general purpose computing (GPGPU). The graphics card may contain GPU memory. In some embodiments no display is present, while in others it is integrated into computer 900. Similarly, peripherals such as input device 914 is connected to system bus 902. Like display 912, these peripherals may be integrated into computer 900 or absent. Also connected to system bus 902 is storage device 908, which may be any form of computer-readable media, such as non-transitory computer readable media, and may be internally installed in computer 900 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface 906 is also attached to system bus 902 and allows computer 900 to communicate over a network such as network 916. Network interface 906 can be any form of network interface known in the art, such as Ethernet, ATM, fiber, Bluetooth, or Wi-Fi (i.e., the Institute of Electrical and Electronics Engineers (IEEE) 802.11 family of standards). Network interface 906 connects computer 900 to network 916, which may also include one or more other computers, such as computer 918, and network storage 922, such as cloud network storage. Network 516 is in turn connected to public Internet 926, which connects many networks globally. In some embodiments, computer 900 can itself be directly connected to public Internet 926.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although described with reference to the embodiments illustrated in the attached drawing figures, it is noted that equivalents may be employed, and substitutions made herein without departing from the scope as recited in the claims. The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects in sufficient detail to enable those skilled in the art to practice the embodiments. Other embodiments can be utilized, and changes can be made without departing from the claimed scope. The following detailed description is, therefore, not to be taken in a limiting sense. The scope of embodiments is defined only by the appended claims, along with the full scope of equivalents to which such claims are entitled.

Having thus described various embodiments, what is claimed as new and desired to be protected by Letters Patent includes the following:

1. One or more non-transitory computer-readable media storing computer-executable instructions that, when executed by at least one processor, perform a method for tracking ephemeral assets in a cloud environment, the method comprising:
creating a knowledge graph model comprising a plurality of nodes and a plurality of relationships between the plurality of nodes;
determining properties of the knowledge graph model for a first node at a first time;
creating a first adjacency list for the first node at the first time;
determining properties of the knowledge graph model for the first node at a second time, wherein the second time is after the first time;
creating a second adjacency list for the first node at the second time; and
comparing the first adjacency list to the second adjacency list to determine at least one change that occurred between the first time and the second time.

2. The non-transitory computer-readable media of claim 1, wherein the properties include a timestamp corresponding to when the first node was added to the knowledge graph model.

3. The non-transitory computer-readable media of claim 1, wherein the method further comprises:
displaying the at least one change to a user via a user interface.

4. The non-transitory computer-readable media of claim 1, wherein the method further comprises:
saving the at least one change to a database for access by a user via a user interface.

5. The non-transitory computer-readable media of claim 1, wherein the properties for each node include at least one of CPU usage, RAM usage, and cost.

6. The non-transitory computer-readable media of claim 1, wherein the method further comprises:
providing a recommendation to a user for where to add a new node to the cloud environment based on analysis of the knowledge graph model using machine learning.

7. The non-transitory computer-readable media of claim 1, wherein the method further comprises:
determining properties of the knowledge graph model for a second node at the first time;
creating a first adjacency list for the second node at the first time;
determining properties of the knowledge graph model for the second node at the second time;
creating a second adjacency list for the second node at the second time; and
comparing the first adjacency list for the second node to the second adjacency list for the second node to determine at least one change that occurred between the first time and the second time at the second node.

8. A method for tracking ephemeral assets in a cloud environment, the method comprising:
creating a knowledge graph model comprising a plurality of nodes and a plurality of relationships between the plurality of nodes;
determining properties of the knowledge graph model for a first node at a first time;
creating a first adjacency list for the first node at the first time;
determining properties of the knowledge graph model for the first node at a second time, wherein the second time is after the first time;
creating a second adjacency list for the first node at the second time; and
comparing the first adjacency list to the second adjacency list to determine at least one change that occurred between the first time and the second time.

9. The method of claim 8, wherein the properties include a timestamp corresponding to when the first node was added to the knowledge graph model.

10. The method of claim 9, further comprising displaying the at least one change to a user via a user interface.

11. The method of claim 8, further comprising: saving the at least one change to a database for access by a user via a user interface.

12. The method of claim 11, wherein the properties for each node include at least one of CPU usage, RAM usage, and cost.

13. The method of claim 8, further comprising:
providing a recommendation to a user for where to add a new node to the cloud environment based on analysis of the knowledge graph model using machine learning.

14. The method of claim 8, further comprising:
determining properties of the knowledge graph model for a second node at the first time;
creating a first adjacency list for the second node at the first time;
determining properties of the knowledge graph model for the second node at the second time;
creating a second adjacency list for the second node at the second time; and
comparing the first adjacency list for the second node to the second adjacency list for the second node to determine at least one change that occurred between the first time and the second time at the second node.

15. A system for tracking ephemeral assets in a cloud environment, the system comprising:
at least one processor; and
at least one non-transitory memory storing computer executable instructions that when executed by the at least one processor cause the system to carry out actions comprising:
creating a knowledge graph model comprising a plurality of nodes and a plurality of relationships between the plurality of nodes;
determining properties of the knowledge graph model for a first node at a first time;
creating a first adjacency list for the first node at the first time;
determining properties of the knowledge graph model for the first node at a second time, wherein the second time is after the first time;
creating a second adjacency list for the first node at the second time; and
comparing the first adjacency list to the second adjacency list to determine at least one change that occurred between the first time and the second time.

16. The system of claim 15, wherein the properties include a timestamp corresponding to when the first node was added to the knowledge graph model.

17. The system of claim 15, wherein the actions further comprise: displaying the at least one change to a user via a user interface.

18. The system of claim 15, wherein the actions further comprise:
saving the at least one change to a database for access by a user via a user interface.

19. The system of claim 18, wherein the properties for each node include at least one of CPU usage, RAM usage, and cost.

20. The system of claim 15, wherein the actions further comprise: providing a recommendation to a user for where to add a new node to the cloud environment based on analysis of the knowledge graph model using machine learning.
